(19) United States
(12) Patent Application Publication
(10) Pub. No.: US 2008/0143291 A1
(43) Pub. Date: Jun. 19, 2008

(54) Communication Apparatus With A Solar Energy Charging Function

(76) Inventors: Kuo-Len Lin, Wugu Township (TW); Tien-Chih Tseng, Wugu Township (TW); Wen-Jung Liu, Wugu Township (TW); Hai-Rui Ye, Wugu Township (TW)

Correspondence Address: HDSL, 4331 STEVENS BATTLE LANE, FAIRFAX, VA, 22033, US

(21) Appl. No.: 12/029,072

(22) Filed: Feb. 11, 2008

Related U.S. Application Data
(63) Continuation-in-part of application No. 11/530,106, filed on Sep. 8, 2006, now abandoned.

(51) Int. Cl. H02J 7/00

(52) U.S. Cl. 320/101

(57) ABSTRACT

A communication apparatus with a solar energy charging function includes a host and a display panel movably and pivotally coupled to the host to define a foldable mobile phone, and a solar panel is coaxially and pivotally coupled to a shaft of the host, such that the solar panel can be folded and covered onto an upper surface of the display panel. If the battery power of the mobile phone is low, users can individually lift the solar panel open from the display panel to charge the battery that is electrically coupled to the mobile phone, so as to enhance the power capacity, using time limit and battery charging requirements of the communication apparatus.

This application is a continuous-in-part application of U.S. patent application Ser. No. 11/530,106, filed on Sep. 8, 2006.

### BACKGROUND OF THE INVENTION

1. Field of the Invention

The present invention relates to a communication apparatus with a solar energy charging function, and more particularly to a communication apparatus that installs a solar panel to a host which is coaxially and pivotally connected to a display panel of a foldable mobile phone for charging a battery anytime when the solar panel is opened from the display panel, so as to facilitate users to charge the battery of the mobile phone and use the mobile phone for communications.

2. Description of Prior Art

At present, a communication apparatus such as a mobile phone and a personal digital assistant (PDA) having a communication function needs a battery for supplying power, but the battery generally comes with a battery capacity, and the idle time or communication time of the communication apparatus is limited by the battery capacity. However, users may not be able to charge a battery of a mobile phone from the utility power, automobile cigarette lighter plug or USB when the battery power is low, since it is inconvenient to carry a battery charger or a power cable. Users usually prepare a second backup battery or a third backup battery to change batteries and maintain the normal communication status of the communication apparatus, but it is still inconvenient to carry or change the backup batteries.

Taiwan Patent Publication No. M285126 entitled “Solar energy mobile phone charger structure” discloses a multi-functional solar energy mobile phone charger that installs a solar panel for converting solar energy into electric energy that is supplied to a lamp, a mobile phone charger, a mosquito repeller, an alarm and an outdoor camping lamp and charges the battery by connecting a power cable to a mobile phone connected to the battery.

Another Taiwan Patent Publication No. 448600 entitled “Method and apparatus for charging a battery of a mobile phone by solar energy” discloses that a solar energy charging apparatus is connected to a battery of a mobile phone, such that the charging apparatus supplies the working power to the mobile phone and uses the remaining electric power capacity to charge the battery.

Although the foregoing patented inventions disclose a way of charging or using a battery of a mobile phone by adopting solar energy as its primary energy sources and converting the solar energy into electric energy in order to charge or use the battery of the mobile phone, the solar energy charging structure still needs to install a charger. In other words, the solar energy charging design integrates to a charger instead of to the mobile phone itself, and thus users still need a solar energy charger and its power cable, which are still inconvenient to carry and use.

### SUMMARY OF THE INVENTION

In view of the foregoing shortcomings of the prior art, the inventor of the present invention based on years of experience in the related industry to conduct experiments and modifications, and finally designed a feasible solution to overcome the shortcomings of the prior art.

Therefore, it is a primary objective of the present invention to overcome the shortcomings of the prior art by providing a simple structure that adopts a hinge structure to pivotally connect a solar panel and a display panel of a foldable mobile phone to a host, and fold the solar panel onto a distal surface of the display panel, such that the solar panel can be lifted open for conveniently and easily charging the battery installed in the mobile phone, and the electric power of the mobile phone can be supplied to the communication apparatus to enhance the carrying of the backup battery and the application of charging a battery in a mobile manner.

To achieve the foregoing objective, the communication apparatus with a solar energy charging function of the invention comprises:

a mobile phone host, having a hinge portion;

a display panel, having a first shaft sleeve installed at an end of the display panel;

a solar panel, having a second shaft sleeve installed at an end of the solar panel; and

a shaft;

such that the first and the second shaft sleeves are coaxially and pivotally coupled to the shaft while two ends of the shaft are fixedly coupled to two hinge ears of the hinge portion, respectively, and thus the solar panel can be folded and covered onto a distal surface of the display panel or lifted open to absorb solar energy to be converted into electric energy for charging a battery that is electrically connected to the host.

### BRIEF DESCRIPTION OF DRAWINGS

The features of the invention believed to be novel are set forth with particularity in the appended claims. The invention itself however may be best understood by reference to the following detailed description of the invention, which describes certain exemplary embodiments of the invention, taken in conjunction with the accompanying drawings in which:

FIG. 1 is a perspective view of a lifted open state in accordance with a preferred embodiment of the present invention;

FIG. 2 is a side view of a lifted open state in accordance with a preferred embodiment of the present invention;

FIG. 3 is a schematic view of a folded close state in accordance with a preferred embodiment of the present invention;

FIG. 4 is a side view of a lifted open state for charging in accordance with a preferred embodiment of the present invention;

FIG. 5 is a perspective view of a lifted open state for charging in accordance with a preferred embodiment of the present invention;

FIG. 6 is a perspective view of a folded state in accordance with another preferred embodiment of the present invention; and

FIG. 7 is a perspective view of a lifted open state for charging in accordance with another preferred embodiment of the present invention.

### DETAILED DESCRIPTION OF THE INVENTION

The technical characteristics, features and advantages of the present invention will become apparent in the following detailed description of the preferred embodiments with reference to the accompanying drawings. However, the drawings are provided for reference and illustration only and are not intended for limiting the scope of the invention.

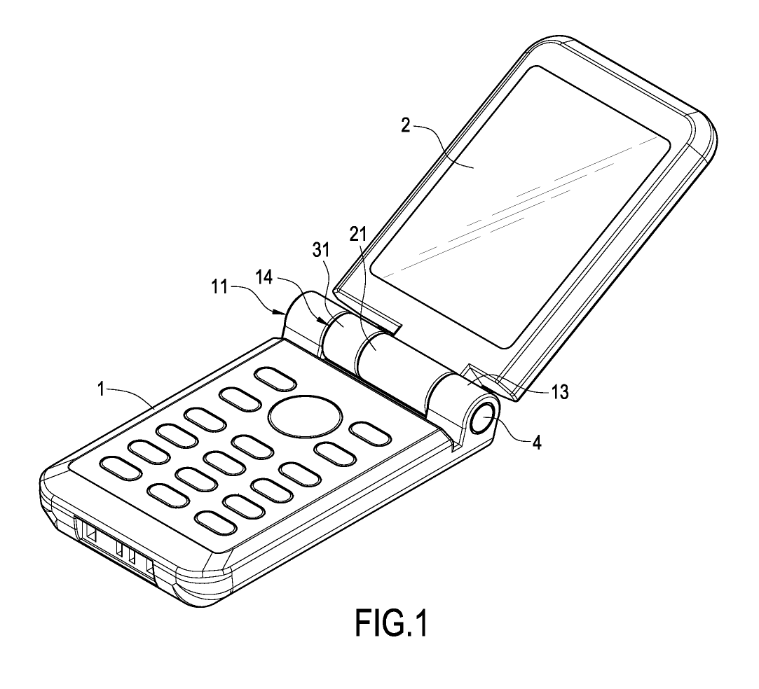

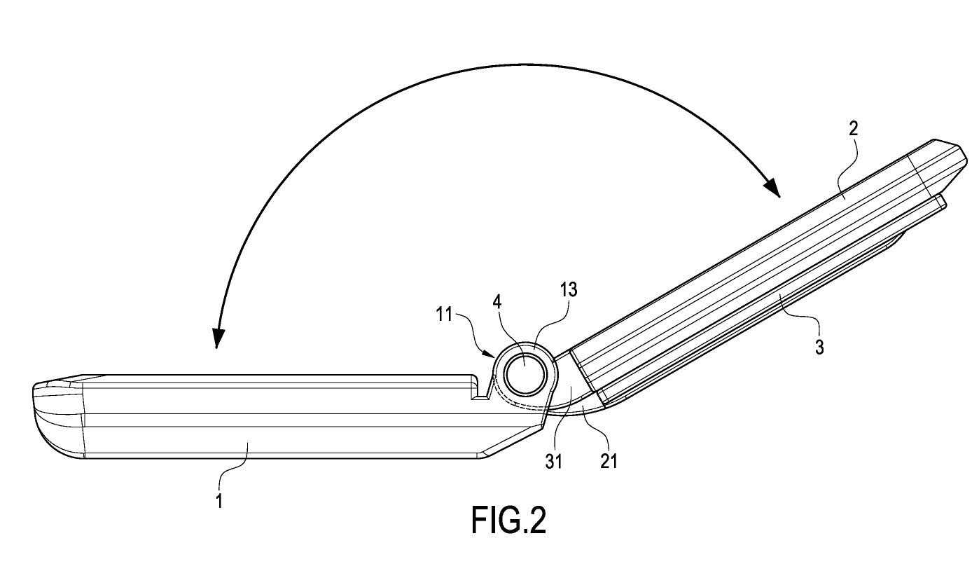

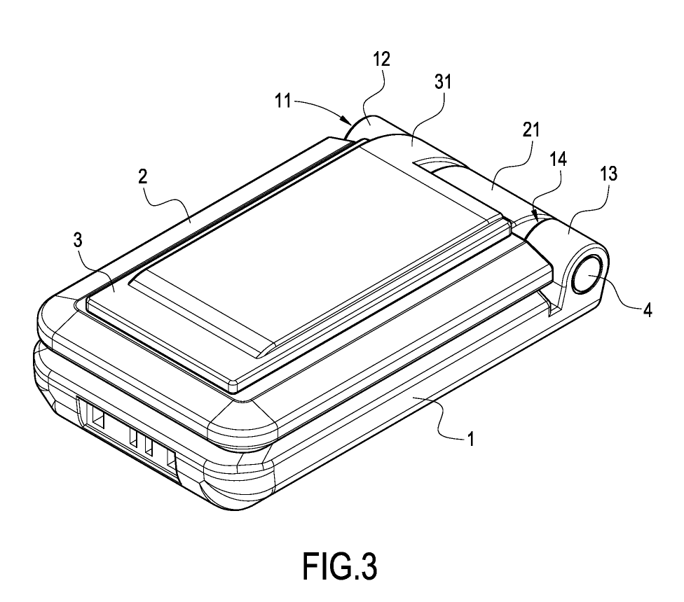

Referring to FIGS. 1 to 3 for a perspective view and a side view of a lifted open state and a schematic view of folded close sate of a communication apparatus with a solar energy charging function in accordance with the present invention, respectively, the communication apparatus with a solar energy charging function of the invention comprises a host 1 of the communication apparatus, a display panel 2, a solar panel 3 and a shaft 4 to define a foldable mobile phone. The host 1 has a hinge portion 11 disposed at the top end of the host 1, and the hinge portion 11 has two hinge ears 12, 13 respectively disposed at two sides with a hinge groove 14 formed therebetween. The display panel 2 and the solar panel 3 are coaxially and pivotally coupled to the shaft 4. The display panel 2 and the solar panel 3 are electrically coupled to a control circuit (not shown in the figure) installed in the host 1. When the solar panel 3 is folded, the solar panel 3 is covered onto an upper surface opposite to a screen surface of the display panel 2 without increasing the volume of the mobile phone or lifted open together with the display panel 2 for the use of communications, or the solar panel 3 is lifted open individually for charging the battery (not shown in the figure) of the mobile phone installed in the host 1 to constitute a communication apparatus structure having a solar charging function, so as to facilitate users to charge the battery of a mobile phone by using the solar panel 3.

The display panel 2 has a first shaft sleeve 21 disposed at its bottom end and pivotally coupled to the shaft 4, and the axial width of the first shaft sleeve 21 is smaller than the width of the hinge groove 14. In other words, the display panel 2 is pivotally coupled to the shaft 4 by using the design of the first shaft sleeve 21, so as to pivotally connect the solar panel 3 by using a pivotal connecting space remained in the hinge groove 14.

The solar panel 3 has a second shaft sleeve 31 disposed at its bottom end and pivotally coupled to the shaft 4, and the axial width and position of the second shaft sleeve 31 are preferably corresponsive to the first shaft sleeve 21 of the display panel 2 in the pivotal connecting space provided in the hinge groove 14. In other words, the sum of the axial width of the second shaft sleeve 31 of the solar panel 3 and the axial width of the first shaft sleeve 21 is preferably equal to or smaller than the width of the hinge groove 14 of the hinge portion 11, such that it is suitable for the second shaft sleeve 31 of the solar panel 3 and the first shaft sleeve 21 of the display panel 2 to be coaxially and pivotally coupled together with the shaft 4 in the hinge groove 14 and for shaft 4 with two ends being fixedly coupled to the two hinge ears 12, 13, respectively, to produce the folding or lifting movements of the display panel 2 and the solar panel 3 with respect to the host 1.

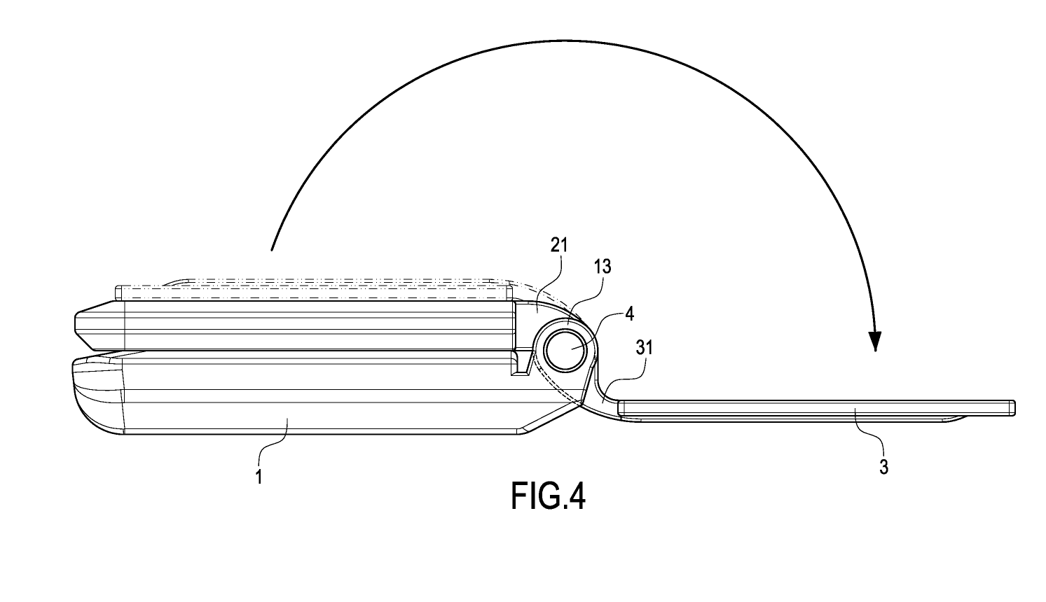

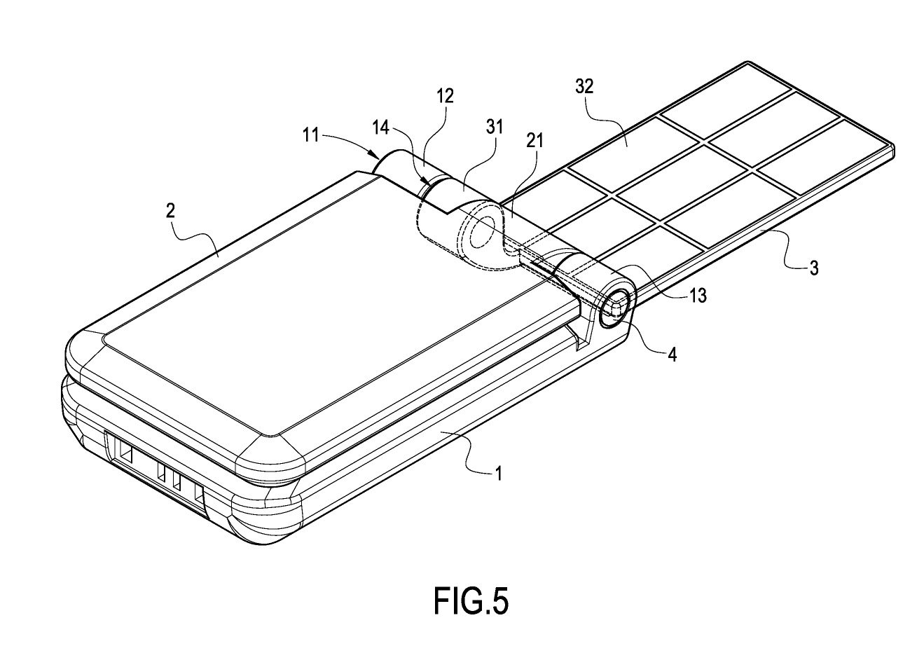

Referring to FIGS. 4 and 5 for a side view and a perspective view of a lifted open state for charging a communication apparatus with a solar energy charging function by solar energy, the communication apparatus with a solar energy charging function of the invention is assembled by the foregoing components. If the battery power of the mobile phone is low, then users can lift the solar panel 3 open from the upper surface opposite the screen surface of the display panel 2 by the second shaft sleeve 31, and use a plurality of solar energy chips 32 installed on a bottom surface of the solar panel 3 to absorb solar energy. After the solar energy is converted into electric energy, the electric energy is used for charging a battery electrically connected to the mobile phone. After the battery is charged, the solar panel 3 is folded and covered onto the upper surface of the display panel 2, and the battery charging of the battery by solar energy will be stopped.

Since the foregoing structure has the solar panel and the display panel coaxially and pivotally coupled to the host to integrate the solar panel with the communication apparatus, the solar panel can be lifted separately for charging the battery of the mobile phone battery, not only extending the using time of the communication apparatus, but also overcoming the problem of carrying a backup battery or a charger for changing or charging the battery without the need of increasing the overall volume or affecting the convenience for the carrying.

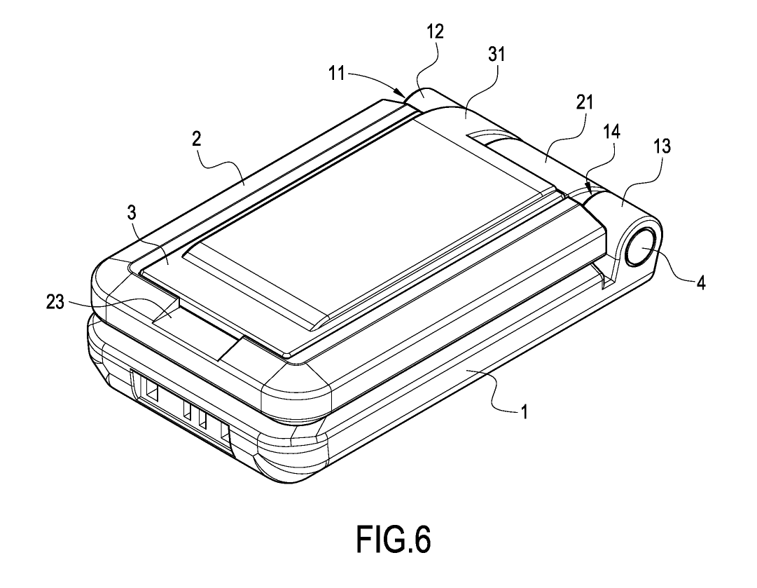

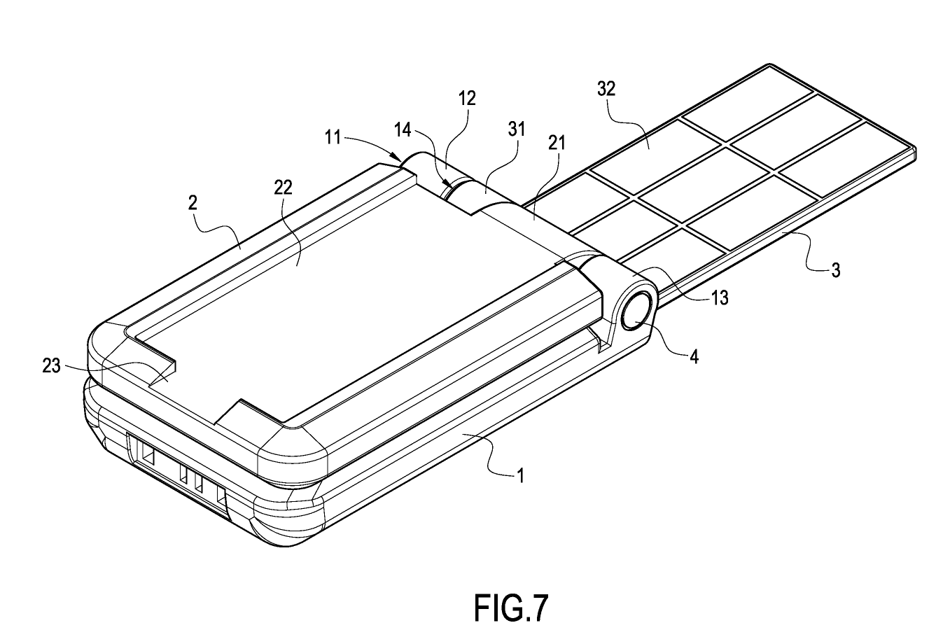

Referring to FIGS. 6 and 7 for schematic views of a lifted open state for charging a communication apparatus with a solar energy charging function in accordance with another preferred embodiment, this preferred embodiment is substantially the same as the embodiment illustrated in FIGS. 1 to 3, and the difference resides on that the display panel 2 has a containing groove 22 corresponding to the solar panel 3 being folded and covered onto the upper surface for containing the folded solar panel 3 to fit a thin design with a small overall volume. Preferably, a breach 23 is set on a lateral side of the containing groove 22 to facilitate users to lift the solar panel 3 from the containing groove 22 for charging the battery of the mobile phone.

According to the design, the height of the containing groove 22 is preferably smaller than, greater than, or equal to the thickness of the solar panel 3 to fit the overall thickness of the communication apparatus.

In summation of the above description, the invention herein enhances the performance than the conventional structure and further complies with the patent application requirements.

In comparison to U.S. Pat. No. 5,260,885, Ma discloses a solar power operated computer comprised of an upper casing “1” having the display “11” and a base “2” pivoted together. However, Ma's upper solar cell assembly “3” is pivotally connected to the upper casing “1” instead of together with the upper casing “1” being pivotally connected to the base “2”. On the other hand, although Ma's lower solar cell assembly “4” is pivotally connected to the base “2”; however, the lower solar cell assembly “4” uses another pivot to be folded on the bottom surface of the base “2” instead of being folded on the upper casing “1”. That is, Ma's structure is not the same as the present invention.

The present invention are illustrated with reference to the preferred embodiment and not intended to limit the patent scope of the present invention. Various substitutions and modifications have suggested in the foregoing description, and other will occur to those of ordinary skill in the art. Therefore, all such substitutions and modifications are intended to be embraced within the scope of the invention as defined in the appended claims.

What is claimed is:

1. A communication device with a solar energy charging function, comprising:
a mobile phone host, having a hinge portion formed at a top end and a key board formed on an upper surface, the hinge portion having two hinge ears at two sides with a hinge groove formed therebetween;
a shaft with two ends fixedly coupled to the hinge ears, respectively;
a display panel, having a screen surface and an upper surface opposite to each other and a first shaft sleeve disposed at a bottom end to be pivotally coupled to the shaft, and the screen surface facing to the key board when the display panel foldably covering on the host;
a solar panel, having an energy chip surface and a second shaft sleeve disposed at a bottom end to be pivotally coupled to the shaft, and the energy chip surface facing to the upper surface of the display panel when the solar panel foldably covering on the display device; and
thereby the solar panel can be folded and lifted synchronously with the display panel for use of communications, and the solar panel can be lifted separately for using the energy chip surface to charge a battery installed in the host.

2. The communication device with a solar energy charging function of claim 1, wherein the display panel has a containing groove formed on the upper surface of the display panel for receiving the solar panel.

3. The communication device with a solar energy charging function of claim 1, wherein the containing groove has a breach disposed on a lateral end of the containing groove for facilitating a separate lift of the solar panel.

4. The communication device with a solar energy charging function of claim 3, wherein the first shaft sleeve has an axial width smaller than that of the hinge groove so that a pivotal connecting space in the hinge groove is remained for the second shaft sleeve.

5. The communication device with a solar energy charging function of claim 4, wherein a sum of the axial width of the first shaft sleeve of the display device and an axial width of the second shaft sleeve of the solar panel is not greater than the width of the hinge groove.

6. The communication device with a solar energy charging function of claim 1, wherein the first shaft sleeve has an axial width smaller than that of the hinge groove.

7. The communication device with a solar energy charging function of claim 6, wherein a sum of the axial width of the first shaft sleeve of the display device and an axial width of the second shaft sleeve of the solar panel is not greater than the width of the hinge groove.
